(19) United States
(12) Patent Application Publication
(10) Pub. No.: US 2013/0151108 A1
(43) Pub. Date: Jun. 13, 2013

(54) METHOD FOR CONTROLLING TORQUE OF ENGINE

(71) Applicants: Chang Kook Chae, Suwon-si (KR); Heungseok Lee, Seoul (KR); Sukil Oh, Suwon-si (KR); Wan Soo Oh, Yongin-si (KR); Jin Hyun Kim, Seoul (KR)

(72) Inventors: Chang Kook Chae, Suwon-si (KR); Heungseok Lee, Seoul (KR); Sukil Oh, Suwon-si (KR); Wan Soo Oh, Yongin-si (KR); Jin Hyun Kim, Seoul (KR)

(73) Assignee: Hyundai Motor Company, Seoul (KR)

(21) Appl. No.: 13/591,928

(22) Filed: Aug. 22, 2012

(30) Foreign Application Priority Data
Dec. 9, 2011 (KR) 10-2011-0131906

(51) Int. Cl. G06F 17/00

(52) U.S. Cl. 701/99

(57) ABSTRACT

A method for controlling an engine torque, may include determining an engagement degree of a clutch in a transmission while a vehicle travels, determining whether a state of the vehicle corresponds to a resonance region where abnormal vibration may be generated by a rigidity change according to the engagement degree, determining whether torque in the vehicle corresponds to a resonance torque region where abnormal vibration may be generated by a rigidity change according to the engagement degree, checking a sub-harmonic value when the engagement degree may be a predetermined degree or more and the vehicle may be in the resonance region and the resonance torque region, and controlling the engine torque to avoid a rigidity change torque when the checked sub-harmonic value may be over a first predetermined value.

### CROSS-REFERENCE TO RELATED APPLICATION

The present application claims priority to Korean Patent Application No. 10-2011-0131906 filed in the Korean Intellectual Property Office on Dec. 9, 2011, the entire contents of which is incorporated herein for all purposes by this reference.

### BACKGROUND OF THE INVENTION

1. Field of the Invention

The present invention relates to a method for controlling torque of an engine, and more particularly, to a method for controlling torque of an engine that can effectively remove vibrations due to the spring rigidity relationship of a damper clutch of a torque converter of an automatic transmission vehicle and abnormal vibrations generated in a double flywheel in a manual transmission vehicle.

2. Description of Related Art

A torque converter (Hydraulic Torque Converter) of an automatic transmission vehicle includes an impeller rotating when receiving a driving force of an engine, a turbine rotated by fluid discharged from the impeller, and a stator (also called a reactor) increasing a torque change rate to change the flow of the fluid, which returns to the impeller, in the rotational direction of the impeller.

According to the configuration, the impeller is fixed to a front cover that is an input side rotary body and makes the internal fluid flow to the turbine while rotating with the front cover, thereby transmitting torque to an output side rotary body from the input side rotary body.

Further, a damper clutch that selectively and directly connects the front cover with the turbine such that the torque is directly transmitted is disposed in the space between the front cover and the turbine, thereby directly transmitting the rotational power of the engine to the turbine.

When the damper clutch is formed to have a double rigidity structure, and as shown in FIG. 1, and when the torque of the engine is inputted at the interface of the rigidity, abnormal vibrations (nonlinear vibrations) are caused by sub-harmonic and fatal vehicle body vibrations are generated.

In order to solve the problem, when high rigidity is designed by increasing the rigidity of the damper clutch with a double rigidity structure, as shown in FIG. 1, excessive booming is generated, such that the NVH (Noise Vibration Harshness) of the engine and fuel efficiency are considerably reduced, and on the contrary, when low rigidity is designed by reducing the rigidity of the damper clutch, booming is improved, but abnormal vibrations become worse, such that there is a contradictory relationship between the booming and the rigidity. As shown in the measurement graph of FIG. 2, since the abnormal vibration generation region and the booming generation region are different, it is difficult to cope with the problem by changing the rigidity of the damper clutch with a double rigidity structure.

Meanwhile, when a damper clutch with a multiple rigidity structure is used to solve the problem, although abnormal vibration and booming are somewhat improved, it is implemented under limitative design conditions (maximum torque and distortion angle), such that it is difficult to actually apply the structure and to appropriately cope with manufacturing difference in damper rigidity and rigidity change due to durability progress

Meanwhile, in a manual transmission vehicle, a DMF (Dual Mass Flywheel) corresponding to the damper clutch of the automatic transmission vehicle is also mounted, and when torque of the engine is inputted at the interference of rigidities, abnormal vibrations (nonlinear vibrations) are caused by sub-harmonic and fatal vehicle body vibrations are generated.

The above information disclosed in this Background region is only for enhancement of understanding of the background of the invention and should not be taken as an acknowledgement or any form of suggestion that this information forms the prior art already known to a person skilled in the art.

### BRIEF SUMMARY

Various aspects of the present invention are directed to providing a method for controlling engine torque having advantages of improving NVH and fuel efficiency of an engine by effectively removing abnormal vibrations in an automatic transmission vehicle or a manual transmission vehicle and of stably implementing the NVH and fuel efficiency of the engine by ensuring strength against a rigidity change due to durability progress and a rigidity change of a damper.

In an aspect of the present invention, a method for controlling an engine torque, may include determining an engagement degree of a clutch in a transmission while a vehicle travels, determining whether a state of the vehicle corresponds to a resonance region where abnormal vibration is generated by a rigidity change according to the engagement degree, determining whether torque in the vehicle corresponds to a resonance torque region where abnormal vibration is generated by a rigidity change according to the engagement degree, checking a sub-harmonic value when the engagement degree is a predetermined degree or more and the vehicle is in the resonance region and the resonance torque region, and controlling the engine torque to avoid a rigidity change torque when the checked sub-harmonic value is over a first predetermined value.

Whether a signal of an accelerator position sensor of the vehicle exceeds a second predetermine value at the timing of controlling the engine torque is determined, and when the signal exceeds the second predetermined value, the rigidity change torque is avoided by controlling the engine torque up, and when the signal is the second predetermined value or less, the rigidity change torque is avoided by controlling the engine torque down.

The resonance region of the vehicle is set from a design value or an experiment value of a resonance region of a driving system including an engine of the vehicle.

The resonance region of the vehicle is a region of a rotation speed range of an engine which is determined in advance for each shift gear of the vehicle.

The resonance torque region is a region within a predetermined range including torque corresponding to discontinuous point of a rigidity of a damper clutch.

The clutch is a damper clutch for an automatic transmission that may have a double rigidity structure by being equipped with a double damper spring.

The clutch is a clutch for a manual transmission and may have a double rigidity structure by being equipped with a dual flywheel.

According to a method for controlling engine torque of the present invention, it is possible to improve NVH and fuel efficiency of an engine by effectively removing abnormal vibrations and to stably implement the NVH and fuel efficiency of the engine by ensuring strength against a rigidity change due to durability progress and a rigidity change of a damper.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing a contradictory relationship between abnormal vibration and booming due to a rigidity change.

FIG. 2 is a diagram showing an experimental graph of abnormal vibration and booming due to a rigidity change.

FIG. 3 is a flowchart of a method for controlling engine torque according to an exemplary embodiment of the present invention.

FIG. 4 is a diagram showing the relationship between an engine torque map and a rigidity change.

FIG. 5 is a graph illustrating a low rigidity design of a damper clutch.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

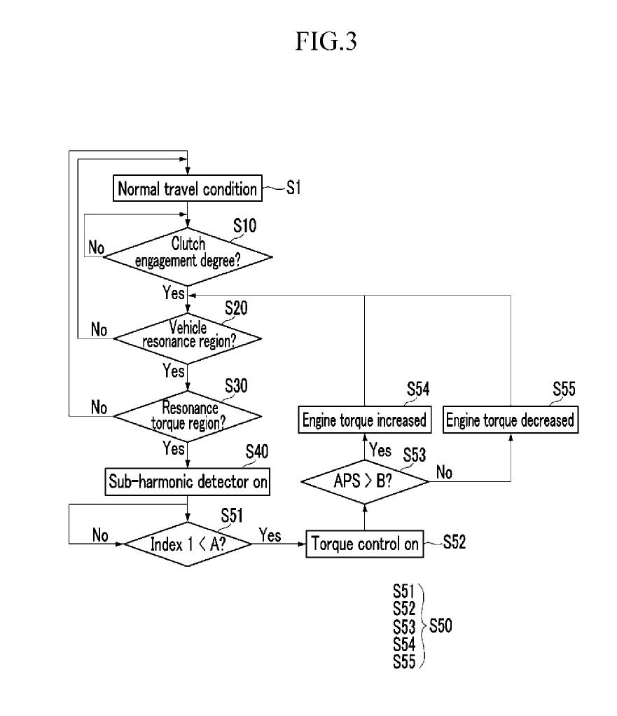

FIG. 3 is a flowchart of a method for controlling engine torque according to an exemplary embodiment of the present invention. As shown in FIG. 3, a method for controlling engine torque according to an exemplary embodiment of the present invention may include: determining the engagement degree of a clutch of a transmission while a vehicle travels (S10), determining whether the state of the vehicle corresponds to a resonance region where abnormal vibration may be generated by a rigidity change according to the engagement degree (S20), determining whether torque in the vehicle corresponds to a resonance torque region where abnormal vibration may be generated by a rigidity change according to the engagement degree (S30), checking sub-harmonic when the engagement degree is a predetermined degree or more and the vehicle is in the resonance region and the resonance torque region (S40), and controlling torque of the engine to avoid the rigidity change torque when the checked sub-harmonic value is over a predetermined value (S50).

The engagement degree of a transmission and a clutch while the vehicle travels is determined in S10 (S10).

The clutch of the vehicle may be a clutch of an automatic transmission vehicle or a clutch of a manual transmission vehicle.

In one or a plurality of exemplary embodiments, the clutch applied to an automatic transmission may be a damper clutch, which may be a damper clutch having a double rigidity structure by having double damper spring structure. Further, in one or a plurality of exemplary embodiment, the clutch applied to a manual transmission may be a DMF (Dual Mass Flywheel).

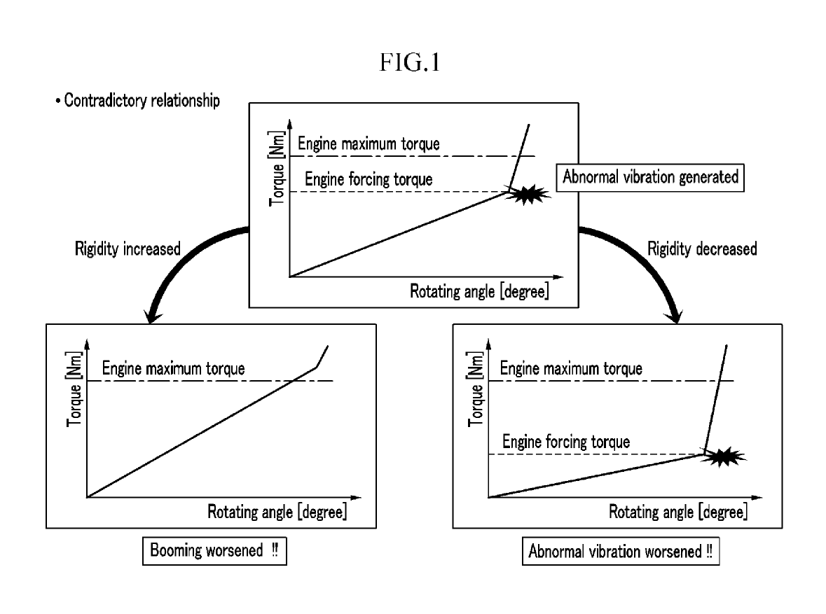

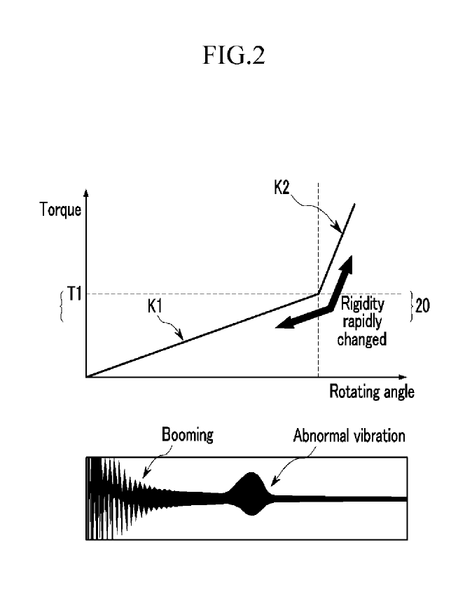

The damper clutch of an automatic transmission which has double rigidity or the clutch of a manual transmission equipped with a DMF, as shown in FIGS. 1 and 2, has a limit in reducing first rigidity K1 and resonant abnormal vibration is generated by vibration reflection due to a rapid rigidity change from the first rigidity K1 to the second rigidity K2. The abnormal vibration, nonlinear vibration, may cause fatal vibration in the vehicle body.

The engagement degree of the clutch which is one of the conditions for the abnormal vibration is determined in S10 (S10).

The engagement degree of the clutch may be divided into a damper clutch of an automatic transmission vehicle and a clutch equipped with a DMF of a manual transmission vehicle.

For the damper clutch, the engagement state is divided into lock-up, slip, and open in accordance with the engagement state, and when the damper clutch is in the lock-up state, abnormal vibration due to a rigidity change is likely to be generated, is not generated in the open state, and is determined in accordance with the degree of slip in the slip state. The less the amount of slip of the damper clutch, the more the abnormal vibration is likely to be generated.

Therefore, when the clutch is a damper clutch of an automatic transmission, it is possible to determine whether the damper clutch is in the slip or lock-up state. One or a plurality of exemplary embodiments, the degree of slip where the possibility of generating abnormal vibration exists is set in accordance with the degree of slip of the damper clutch, and only in this case, it can be set to satisfy the condition of the determining (S10) of the present invention.

Meanwhile, when the transmission is a manual transmission, similarly, abnormal vibration due to a rigidity change is not generated when the clutch is engaged, so that it may be set to determine whether there is abnormal vibration only when the clutch is completely engaged or engaged at a predetermined level or more.

Further, as shown in FIG. 3, it is determined whether the state of the vehicle corresponds to the resonance region where abnormal vibration may be generated by the clutch (S20).

Since not only the state of the clutch, but the state of the vehicle may be under a specific situation where abnormal vibration may be generated, this case is considered. As shown in FIG. 2, as the section where abnormal vibration is generated is a specific region, it is checked that the RPM or the like of the vehicle is in the resonance region in order to set the specific region as a resonance region.

In one or a plurality of exemplary embodiments, the resonance region of the vehicle may be set from a design value or an experiment value of the resonance region of a driving system including the engine of the vehicle.

Further, according to an exemplary embodiment of the present invention, the resonance region of the vehicle may be the region of the rotation speed range of the engine which is determined for each shift gear of the vehicle.

As described above, the resonance region of the vehicle is the region where abnormal vibration may be generated in the vehicle, such that it is possible to set the resonance region in advance by checking the rotation speed range of the engine where abnormal vibrations may be generated for each shift gear, through an experiment or the like. For example, when the vehicle is at the fifth shift gear and the rotation speed of the engine is within 1800-2000 RPM, it may be possible to determine that the vehicle is in the resonance region. The control unit, such as an ECU or a TCU, of the vehicle determines whether the state of the vehicle is in the resonance region on the basis of information transmitted from an engine rotation speed sensor.

Further, the rotation speed range of the engine described above may be set the same or different for each shift gear.

Meanwhile, as shown in FIG. 3, it is determined whether the torque in the vehicle corresponds to the resonance torque region where abnormal vibration may be generated by the damper clutch (S30). There is a torque range where abnormal vibration may be generated, not only in the rotation speed of the engine at each shift gear of the vehicle, but the torque.

As shown in FIG. 2, the torque value corresponding to the point where the rigidity rapidly changes from K1 to K2 in the damper clutch with a double rigidity structure is T1. When the torque is T1 in the vehicle, resonant abnormal vibration may be generated by a rigidity change.

Therefore, the resonance torque region where abnormal vibration may be generated may be set as a torque region 20 within a predetermine range from T1 in FIG. 2. The range of the resonance torque region 20 may be set by an experiment or analysis.

In one or a plurality of exemplary embodiments, the resonance torque region 20 may also be set the same or different for each shift gear in the vehicle. In practice, the torque where abnormal vibration may be generated at each shift gear of the vehicle is generally within the range of about 70% of the maximum torque of the engine at each shift gear, such that the resonance torque region 20 may be set in consideration of the fact.

Next, as shown in FIG. 3, when the engagement degree of the clutch is above a predetermined degree (S10), the vehicle is in the resonance region (S20), and the torque of the vehicle is in the resonance torque region (S30), checking sub-harmonic is performed (S40).

That is, when the conditions of the three determinings (S10, S20, and S30) are satisfied, sub-harmonic of the vehicle is checked (S40). Although the value of the sub-harmonic may be checked by specific equipment for measuring the sub-harmonic, in one or a plurality of exemplary embodiments, the control unit such as the ECU or the TCU of the vehicle may check the value A converted from the rotation speed PGB of the output shaft of the transmission of the vehicle in an exemplary embodiment of the present invention.

Meanwhile, as shown in FIG. 3, the checked value A of the sub-harmonic exceeds a predetermined value (Index 1), the torque of the engine is controlled to avoid the rigidity change torque (S50).

The predetermined value (Index 1) is a value (Index 1) that is an index and may be set in advance by experiment or analysis.

In one or a plurality of exemplary embodiments, the predetermine value (Index 1) may be set to a half order of the main firing component of the engine of the vehicle. For example, the main firing component is C2 in an 14 engine. That is, the main firing component of the 14 engine is C2 where the engine revolves two times when the crankshaft rotates one time. C1 that is a haft C2 is set as the predetermined value (index value). C1 that is a half C2 is a value where the crankshaft rotates one time when the engine revolves four times in the 14 engine.

Similarly, in an 16 engine or a V6 engine, C1.5 that is a half the main firing component C3 may be used as the index value (Index 1), and in a V8 engine, C2 that is a half a main firing component C4 may be used as the index value (Index 1).

However, this is one of the methods of setting an index value and is not limitative.

In one or a plurality of exemplary embodiments, the controlling S50 of torque of an engine to avoid the rigidity change torque may be separately performed in various steps S51-S55, as shown in FIG. 3.

It is determined whether the sub-harmonic value A exceeds the predetermine value (Index1) (S51), and it is determined whether a signal from the APS (Accel Position Sensor) of the vehicle exceeds a predetermine value B at the timing (S52) of controlling the engine torque, from the above determination (S53).

In one or a plurality of exemplary embodiments, when the signal exceeds the predetermine value B in the determination S53, it is possible to avoid the rigidity change torque by controlling the engine torque up (S54), and when the signal is the predetermined value B or less, it is possible to avoid the rigidity change torque by controlling the engine torque down.

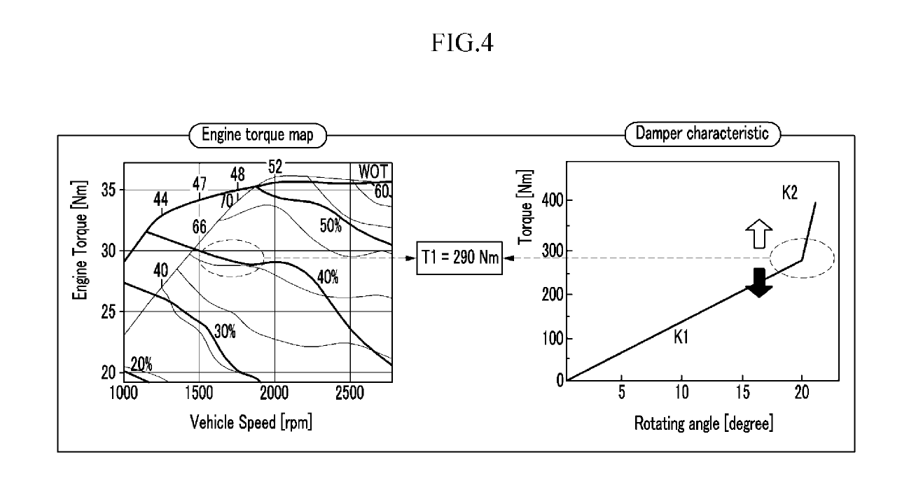

Describing this with reference to FIG. 4, the torque at the point T1 is about 290 Nm in the rigidity change graph at the right side in FIG. 4. That is, T1 is the torque where abnormal vibration may be generated by a rigidity change of the clutch. When the torque in the vehicle is T1 with all the conditions of S10-S30 satisfied, abnormal vibration is generated.

When finding the point corresponding to this case from the engine torque map at the left, a torque point corresponding to T1 in accordance with the engine rotation speed region of the vehicle may be selected. It is possible to avoid abnormal vibration by controlling the torque of the vehicle upward or downward such that the torque of the vehicle becomes beyond the corresponding torque point.

When a signal of an APS exceeds a predetermined value B (S53), the driver intends to accelerate, and accordingly, it is preferable in this case to control the engine torque above T1 in order to avoid abnormal vibration (S54).

On the contrary, the signal of the APS is set to be less than the predetermined value B (S53), the driver does not intend to accelerate, and accordingly, it is preferable in this case to control the engine torque above T1 in order to avoid abnormal vibration (S55).

As described above, according to a method for controlling a damper clutch of an exemplary embodiment of the present invention, it is possible to prevent abnormal vibration from being generated by controlling the torque of an engine to avoid the torque of a rigidity change point where abnormal vibration may be generated, under the circumference where abnormal vibration may be generated by a rapid rigidity change in a clutch of an automatic transmission or a manual transmission having a rigidity change structure.

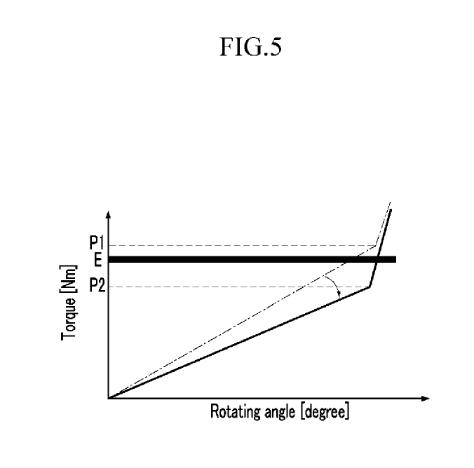

Meanwhile, in the related art, the rigidity of a clutch was increased such that torque P1 at the boundary point is larger than the maximum torque E of an engine, as shown in FIG. 5, in order to prevent the abnormal vibration, but this configuration caused a problem in that booming became worse, as in FIG. 1.

However, according to a method for controlling an engine of an exemplary embodiment of the present invention, in the clutch shown in FIG. 5, even through the torque P2 at the boundary point of a rigidity change is smaller than the maximum torque E of the engine, it is possible to remove abnormal vibration by controlling the engine torque at the point to avoid the torque P2. Therefore, as a low-rigidity design for the damping clutch becomes possible and booming can be improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling an engine torque, comprising:
determining an engagement degree of a clutch in a transmission while a vehicle travels;
determining whether a state of the vehicle corresponds to a resonance region where abnormal vibration is generated by a rigidity change according to the engagement degree;
determining whether torque in the vehicle corresponds to a resonance torque region where abnormal vibration is generated by a rigidity change according to the engagement degree;
checking a sub-harmonic value when the engagement degree is a predetermined degree or more and the vehicle is in the resonance region and the resonance torque region; and
controlling the engine torque to avoid a rigidity change torque when the checked sub-harmonic value is over a first predetermined value.

2. The method of claim 1, wherein:
whether a signal of an accelerator position sensor of the vehicle exceeds a second predetermine value at the timing of controlling the engine torque is determined, and when the signal exceeds the second predetermined value, the rigidity change torque is avoided by controlling the engine torque up, and when the signal is the second predetermined value or less, the rigidity change torque is avoided by controlling the engine torque down.

3. The method of claim 1, wherein:
the resonance region of the vehicle is set from a design value or an experiment value of a resonance region of a driving system including an engine of the vehicle.

4. The method of claim 1, wherein:
the resonance region of the vehicle is a region of a rotation speed range of an engine which is determined in advance for each shift gear of the vehicle.

5. The method of claim 1, wherein:
The resonance torque region is a region within a predetermined range including torque corresponding to discontinuous point of a rigidity of a damper clutch.

6. The method of claim 1, wherein:
the clutch is a damper clutch for an automatic transmission that has a double rigidity structure by being equipped with a double damper spring.

7. The method of claim 1, wherein:
the clutch is a clutch for a manual transmission and has a double rigidity structure by being equipped with a dual flywheel.
